(19) United States
(12) Patent Application Publication
(10) Pub. No.: US 2019/0018535 A1
(43) Pub. Date: Jan. 17, 2019

(54) TOUCH SENSOR AND INPUT DEVICE EQUIPPED WITH SAME

(71) Applicant: Panasonic Intellectual Property Managerment Co., Ltd., Osaka (JP)

(72) Inventor: HIDENORI KITAMURA, Osaka (JP)

(21) Appl. No.: 16/068,949

(22) PCT Filed: Dec. 22, 2016
(86) PCT No.: PCT/JP2016/005207

§ 371 Date: Jul. 10, 2018

(30) Foreign Application Priority Data
Feb. 1, 2016 (JP) 2016-017027

(51) Int. Cl. G06F 3/041; G06F 3/044

(52) U.S. Cl. CPC G06F 3/0416; G06F 2203/04107; G06F 2203/04111; G06F 3/044

(57) ABSTRACT

A touch sensor according to the present invention includes: a plurality of driving electrodes that are disposed with a predetermined distance while a first direction is set to a longitudinal direction of the driving electrodes; and a plurality of detection electrodes that are disposed with a predetermined distance while a second direction orthogonal to the first direction is set to a longitudinal direction of the detection electrodes. A width of the driving electrode is larger than a width of the detection electrode, and an opening is formed only in the driving electrode at an intersection of the driving electrode and the detection electrode.

### TECHNICAL FIELD

The present invention relates to a capacitive touch sensor and an input device including the touch sensor.

### BACKGROUND ART

In the capacitive touch sensor, a plurality of driving electrodes and a plurality of detection electrodes are disposed with an insulating layer interposed therebetween while being orthogonal to each other, and capacitance is provided at an intersection of the driving electrode and the detection electrode. When an operating body such as a fingertip (hereinafter, simply referred to as an “operating body”) approaches the intersection, electrostatic coupling is generated between the operating body and the driving electrode and detection electrode, and thus the capacitance is changed at the intersection. A position of the operating body is detected by detecting the change in capacitance.

When the capacitance at the intersection is large, the change in capacitance due to the approach of the operating body is decreased, and sensitivity of the position detection (hereinafter, simply referred to as “detection sensitivity”) is degraded. Meanwhile, when the touch sensor is provided in an operating surface as an input interface such as a display panel, the display panel and the like become a noise generating source. For this reason, the touch sensor is easily affected by the noise from the display panel and the like. An electrode pattern is designed such that the noise from the display panel and the like is shielded by increasing a width of the driving electrode, and such that the capacitance at the intersection is decreased by decreasing a width of the detection electrode.

However, when the width of the detection electrode is decreased, an electrode resistance of the detection electrode is increased. Consequently, a time constant is increased to lengthen a detection time, and responsiveness of the position detection (hereinafter, simply referred to as detection responsiveness) is degraded.

In order to solve the problems, PTL 1 discloses a capacitive touch sensor in which a slit is formed in the detection electrode opposite to the driving electrode. When voltage is applied to the driving electrode and the detection electrode, a fringe field (a leakage electric field generated from a boundary of the driving electrode) going around a side face or a front surface of the detection electrode is also generated through the slit in addition to an electric field generated between the driving electrode and the detection electrode, which are opposite to each other. Consequently, when the operating body approaches the intersection, the change in capacitance is increased because the operating body shields the fringe field. As a result, the detection sensitivity can be improved. The electrode resistance of the detection electrode can be maintained by increasing a width of other portions except for the portion in which the slit of the detection electrode is provided. Consequently, the degradation of the detection responsiveness can be prevented.

### CITATION LIST

### Patent Literature

PTL 1: Japanese Unexamined Patent Publication No. 2010-250770

### SUMMARY OF THE INVENTION

An object of the present invention is to provide a touch sensor that has the excellent detection sensitivity and detection responsiveness even if electrode pitches of the driving electrode and the detection electrode are reduced to detect the position with higher accuracy, and to provide an input device equipped with the touch sensor.

According to one aspect of the present invention, a touch sensor includes: a plurality of driving electrodes that are disposed with a predetermined distance while a first direction is set to a longitudinal direction of the driving electrodes; and a plurality of detection electrodes that are disposed with a predetermined distance while a second direction orthogonal to the first direction is set to a longitudinal direction of the detection electrodes. A width of the driving electrode is larger than a width of the detection electrode, and an opening is formed only in the driving electrode at an intersection of the driving electrode and the detection electrode.

According to another aspect of the present invention, an input device equipped with the touch sensor.

The present invention can provide the touch sensor, which has the excellent detection sensitivity and detection responsiveness and can accurately detect the position, and the input device equipped with the touch sensor.

### BRIEF DESCRIPTION OF DRAWINGS

FIG. 1 is an exploded perspective view schematically illustrating a configuration of a touch sensor according to a first exemplary embodiment of the present invention.

FIG. 2 is a plan view schematically illustrating an electrode pattern of the touch sensor of the first exemplary embodiment of the present invention.

FIG. 3 is a plan view schematically illustrating an electrode pattern of a driving electrode.

FIG. 4 is a plan view schematically illustrating an electrode pattern of a detection electrode.

FIG. 5A is an enlarged plan view illustrating an intersection of a driving electrode and a detection electrode in the electrode pattern of FIG. 2.

FIG. 5B is a sectional view taken along line Vb-Vb in FIG. 5A.

FIG. 5C is a sectional view taken along line Vc-Vc in FIG. 5A.

FIG. 6 is a plan view schematically illustrating an electrode pattern of a touch sensor according to a second exemplary embodiment of the present invention.

FIG. 7 is a partially enlarged plan view illustrating parts of an electrode pattern of the driving electrode in the electrode pattern of FIG. 6.

FIG. 8 is a plan view schematically illustrating an electrode pattern of a touch sensor according to a third exemplary embodiment of the present invention.

FIG. 9 is a partially enlarged plan view illustrating parts of electrode patterns of the driving electrodes adjacent to each other in the electrode pattern of FIG. 8.

FIG. 10 is a plan view schematically illustrating an electrode pattern of a touch sensor according to a fourth exemplary embodiment of the present invention.

FIG. 11 is a partially enlarged plan view illustrating parts of electrode patterns of the driving electrodes adjacent to each other in the electrode pattern of FIG. 10.

FIG. 12 is a plan view schematically illustrating an electrode pattern of a touch sensor according to a fifth exemplary embodiment of the present invention.

FIG. 13 is a partially enlarged plan view illustrating parts of electrode patterns of the driving electrodes adjacent to each other in the electrode pattern of FIG. 12.

FIG. 14 is a plan view schematically illustrating an electrode pattern of a touch sensor according to a sixth exemplary embodiment of the present invention.

FIG. 15 is a partially enlarged plan view illustrating parts of electrode patterns of the driving electrodes adjacent to each other in the electrode pattern of FIG. 14.

### DESCRIPTION OF EMBODIMENTS

Problems in the conventional touch sensor will be briefly described prior to the description of exemplary embodiments of the present invention. In the capacitive touch sensor, to accurately detect the position, it is necessary to decrease electrode pitches of the driving electrode and the detection electrode. However, since the width of the detection electrode is narrowed according to the decrease in electrode pitch, the electrode resistance of the detection electrode is increased when the slit is formed in the detection electrode. Consequently, the time constant is increased to lengthen the detection time, and the detection responsiveness is degraded. Since an area of the detection electrode at the intersection becomes smaller by the formation of the slit, the capacitance between the detection electrode and the operating body is decreased when the operating body approaches the intersection. As a result, the change in capacitance is decreased at the intersection, and the detection sensitivity is degraded. Additionally, when the width of the detection electrode is narrowed, the width of the slit is also narrowed, and the fringe field is decreased through the slit. Consequently, when the operating body approaches the intersection, the change in capacitance obtained by an effect of the fringe field is decreased, and therefore the total change in capacitance is decreased to degrade the detection sensitivity.

Hereinafter, exemplary embodiments of the present invention will be described in detail with reference to the drawings. The present invention is not limited to the following exemplary embodiments. The modifications can be made appropriately to the exemplary embodiments without departing from the scope of the present invention.

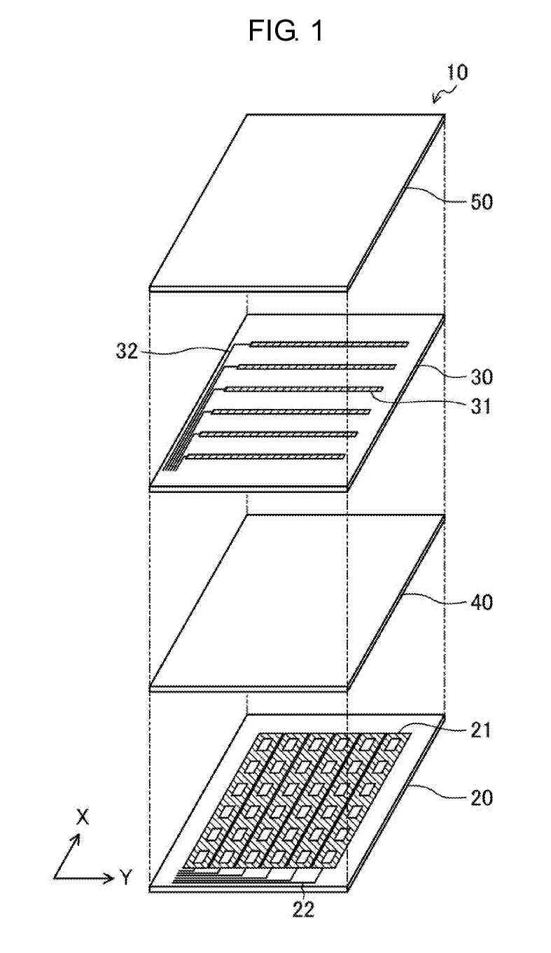

FIG. 1 is an exploded perspective view schematically illustrating a configuration of touch sensor 10 according to a first exemplary embodiment of the present invention.

As illustrated in FIG. 1, a plurality of driving electrodes 21 are disposed in first support 20 while an X-direction is set to a longitudinal direction of driving electrodes 21, and a plurality of detection electrodes 31 are disposed in second support 30 while a Y-direction is set to a longitudinal direction of detection electrodes 31. First support 20 and second support 30 are joined to each other with insulating layer 40 interposed therebetween, and a front surface of second support 30 is protected by cover 50.

First wiring 22 is connected to each of driving electrodes 21, and second wiring 32 is connected to each of detection electrodes 31. A controller (not illustrated) applies voltage to driving electrode 21 through selected first wiring 22, and detects a change in capacitance at an intersection of driving electrode 21 and detection electrode 31 through second wiring 32. As a result, the controller performs arithmetic processing of the change in capacitance to detect a touch position of the operating body.

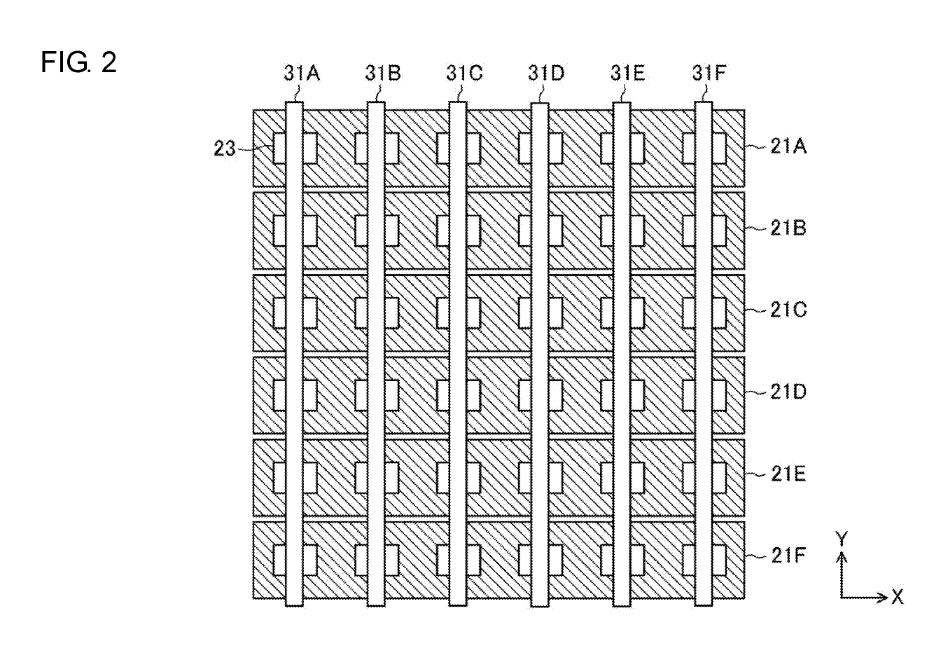

FIG. 2 is a plan view schematically illustrating an electrode pattern of touch sensor 10 of the first exemplary embodiment. In FIG. 2, a plurality of driving electrodes 21A to 21F are hatched.

As illustrated in FIG. 2, the plurality of driving electrodes 21A to 21F are disposed with a predetermined distance between the driving electrodes adjacent to each other while the X-direction (first direction) is set to the longitudinal direction of the driving electrode. A plurality of detection electrodes 31A to 31F are disposed with a predetermined distance between the detection electrodes adjacent to each other while the Y-direction (second direction) orthogonal to the X-direction is set to the longitudinal direction of the detection electrode. Consequently, each of the intersections of driving electrodes 21A to 21F and detection electrodes 31A to 31F, which are opposite to each other with insulating layer 40 interposed therebetween, constitutes the capacitance.

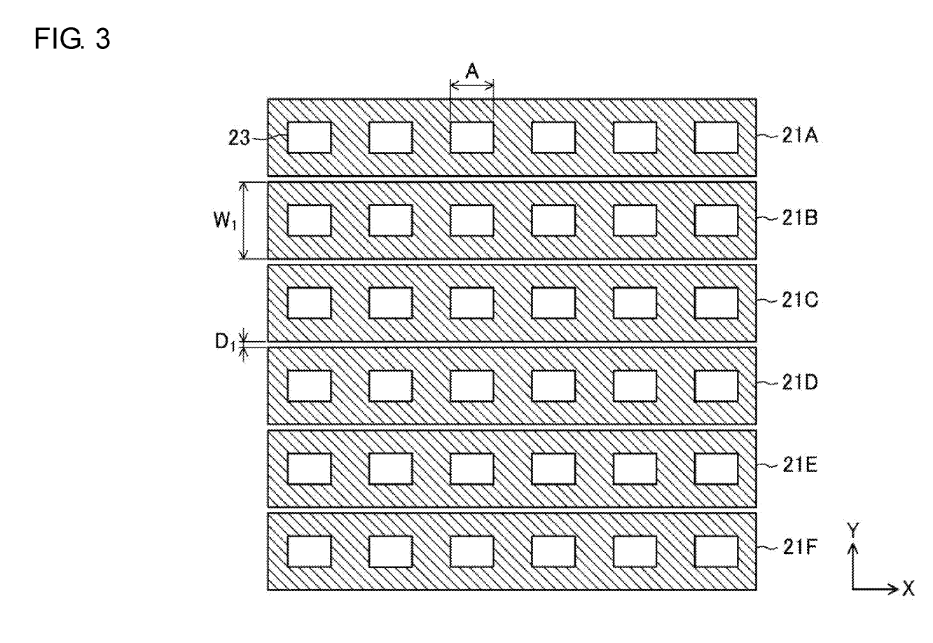

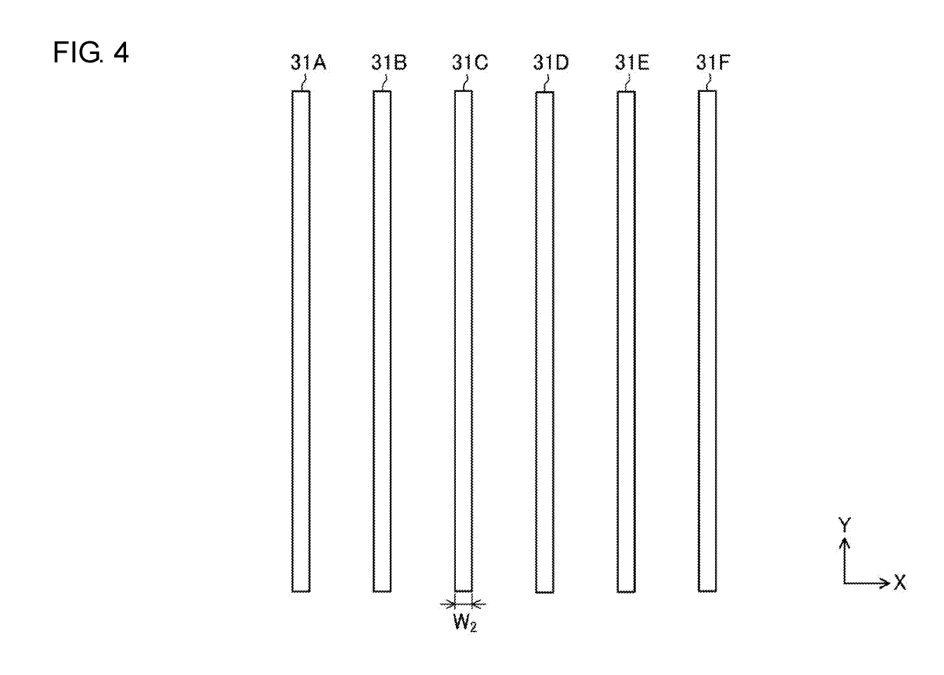

FIG. 3 is a plan view schematically illustrating electrode patterns of driving electrodes 21A to 21F. FIG. 4 is a plan view schematically illustrating electrode patterns of detection electrodes 31A to 31F.

As illustrated in FIGS. 3 and 4, width W₁ of each of driving electrodes 21A to 21F is larger than width W₂ of each of detection electrodes 31A to 31F. Opening 23 are formed only in driving electrodes 21A to 21F at the intersections of driving electrodes 21A to 21F and detection electrodes 31A to 31F. Width A of opening 23 in the X-direction is larger than width W₂ of each of detection electrodes 31A to 31F. Preferably, distance D₁ between driving electrodes 21A to 21F adjacent to each other is narrowed as much as possible to such a degree that driving electrodes 21A to 21F can electrically be insulated from one another to shield noise from a display panel or the like.

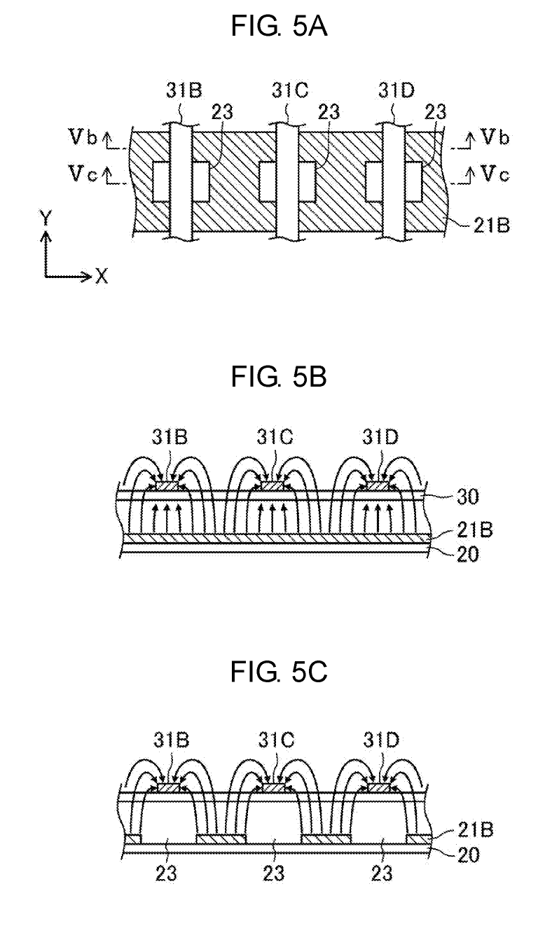

FIG. 5A is a partially enlarged plan view illustrating intersections of driving electrode 21B and detection electrodes 31B to 31D in the electrode pattern of FIG. 2, FIG. 5B is a sectional view taken along line Vb-Vb in FIG. 5A, and FIG. 5C is a sectional view taken along line Vc-Vc in FIG. 5A.

As illustrated in FIG. 5B, when the voltage is applied to driving electrode 21B, an electric field is generated between driving electrode 21B and opposite detection electrodes 31B to 31D. The fringing field going around the side face or the front surface of detection electrodes 31B to 31D is also generated in addition to the electric field generated between the electrodes opposite to each other. Because the electric field radiating in an upward direction is shielded by detection electrodes 31B to 31D, a change in capacitance is decreased during an approach of the operating body such as the fingertip and a point of a touch pen.

On the other hand, as illustrated in FIG. 5C, the fringing field is generated in a region where opening 23 is formed in driving electrode 21B. Compared with the case that opening 23 is not formed in driving electrode 21B, a change in capacitance generated at the intersections of driving electrode 21B and detection electrodes 31B to 31D is increased during the approach of the operating body. As a result, the detection sensitivity can be enhanced when the operating body approaches the intersection.

Even if the widths of detection electrodes 31A to 31F are narrowed to detect the position with higher accuracy, by providing openings 23 in driving electrodes 21A to 21F, the same effect as the effect that enhances the detection sensitivity by forming the slits in detection electrodes 31A to 31F can be obtained like a conventional case.

In the first exemplary embodiment, it is not necessary to form the slit in detection electrodes 31A to 31F, so that a reduction of an area of the detection electrode can be prevented at the intersection. Consequently, a decrease in capacitance between detection electrodes 31A to 31F and the operating body can be prevented during the approach of the operating body. As a result, degradation of the detection sensitivity due to the small change in capacitance can be prevented.

Additionally, it is not necessary to form the slit in detection electrodes 31A to 31F, so that an increase in electrode resistance of detection electrodes 31A to 31F can be prevented. Consequently, the degradation of the detection responsiveness caused by increasing a time constant to lengthen a detection time can be prevented.

Additionally, it is not necessary to form the slit in detection electrodes 31A to 31F, so that the reduction of the area of detection electrodes 31A to 31F can be prevented at the intersection. Consequently, the decrease in capacitance between detection electrodes 31A to 31F and the operating body can be prevented during the approach of the operating body. As a result, the degradation of the detection sensitivity due to the small change in capacitance can be prevented.

When openings 23 are provided in driving electrodes 21A to 21F, there is concern that an influence of the noise from the outside such as the display panel is increased. The detection sensitivity of the touch sensor is defined by a ratio of a detection signal detected from detection electrode 31A to 31F to noise (SNR). The detection signal is decided by capacitance between driving electrodes 21A to 21F and detection electrodes 31A to 31F, capacitance between the operating body and driving electrodes 21A to 21F, and capacitance between the operating body and detection electrodes 31A to 31F.

In the first exemplary embodiment, the capacitance between the operating body and driving electrodes 21A to 21F and the capacitance between the operating body and detection electrodes 31A to 31F can be increased by forming openings 23 in driving electrodes 21A to 21F at the intersections of driving electrodes 21A to 21F and detection electrodes 31A to 31F. Because openings 23 are formed only at the intersections of driving electrodes 21A to 21F and detection electrodes 31A to 31F, a total area of openings 23 is much smaller than a total area of driving electrodes 21A to 21F. For this reason, the detection signal can be increased larger than a noise increase caused by providing openings 23 in driving electrodes 21A to 21F. Consequently, the detection sensitivity of the touch sensor can be improved.

As described above, in the first exemplary embodiment, the touch sensor having the excellent detection sensitivity and detection responsiveness can be constructed even if the electrode pitches of driving electrodes 21A to 21F and detection electrode 31A to 31F are reduced to detect the position with higher accuracy.

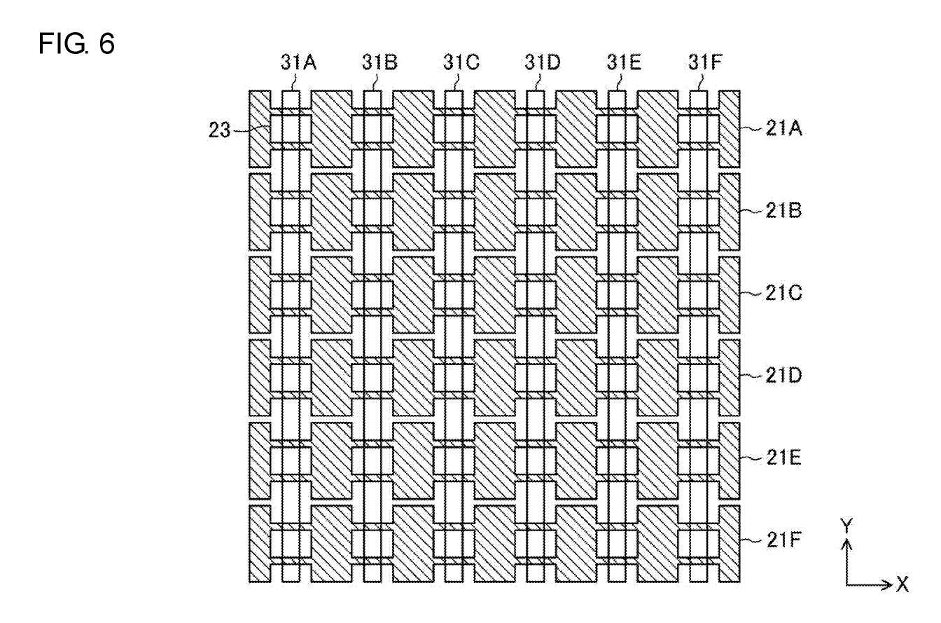

FIG. 6 is a plan view schematically illustrating an electrode pattern of a touch sensor according to a second exemplary embodiment of the present invention. In FIG. 6, the plurality of driving electrodes 21A to 21F are hatched.

As illustrated in FIG. 6, the plurality of driving electrodes 21A to 21F are disposed with a predetermined distance between the driving electrodes adjacent to each other while the X-direction is set to the longitudinal direction of the driving electrode. The plurality of detection electrodes 31A to 31F are disposed with a predetermined distance between the detection electrodes adjacent to each other while the Y-direction orthogonal to the X-direction is set to the longitudinal direction of the detection electrode. Consequently, each of the intersections of driving electrodes 21A to 21F and detection electrodes 31A to 31F, which are opposite to each other with insulating layer 40 interposed therebetween, constitutes the capacitance.

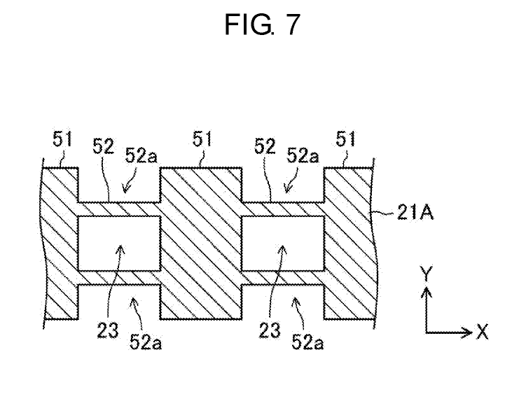

FIG. 7 is a partially enlarged plan view illustrating parts of an electrode pattern of driving electrode 21A in the electrode pattern of FIG. 6.

As illustrated in FIG. 7, driving electrode 21A includes narrow portion 52 narrower than other regions (wide portion) 51 at the intersection. That is, the electrode patterns of driving electrodes 21A to 21F of the second exemplary embodiment include recesses 52a in which both ends in a width direction of driving electrodes 21A to 21F are recessed toward the side of opening 23 at the intersection.

In the second exemplary embodiment, in addition to the fringe field generated through opening 23, the fringe field cam also be generated through the recess 52a by forming recesses 52a at the intersection of driving electrodes 21A to 21F. Consequently, when the operating body approaches the intersection, the change in capacitance is further increased because the operating body shields the fringe field. As a result, the detection sensitivity can further be improved.

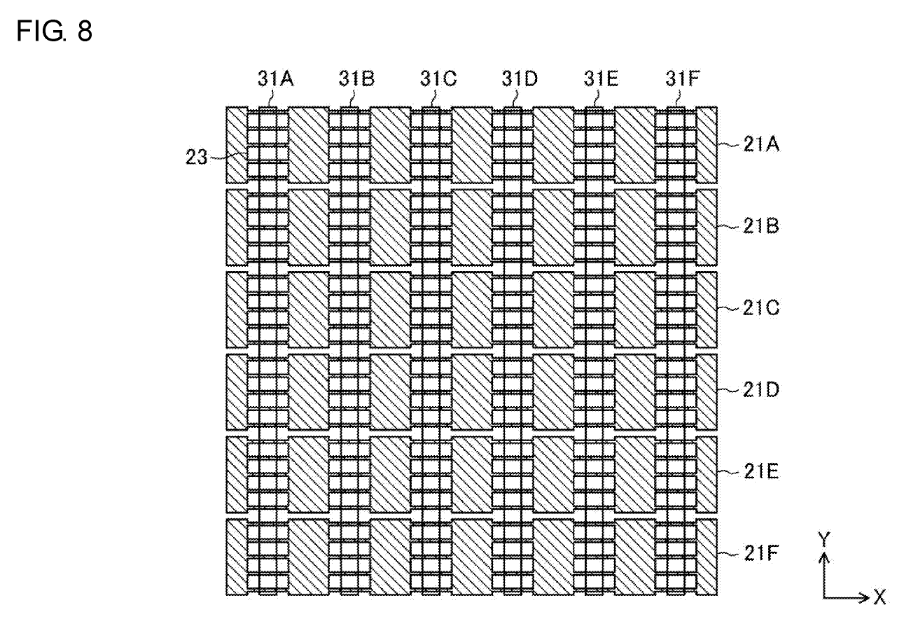

FIG. 8 is a plan view schematically illustrating an electrode pattern of a touch sensor according to a third exemplary embodiment of the present invention. In FIG. 8, the plurality of driving electrodes 21A to 21F are hatched.

In the third exemplary embodiment, a plurality of openings 23 are formed at intervals in the Y-direction. Consequently, more fringe fields can be generated through the plurality of openings 23. As a result, the detection sensitivity can further be improved because the change in capacitance is further increased when the operating body approaches the intersection.

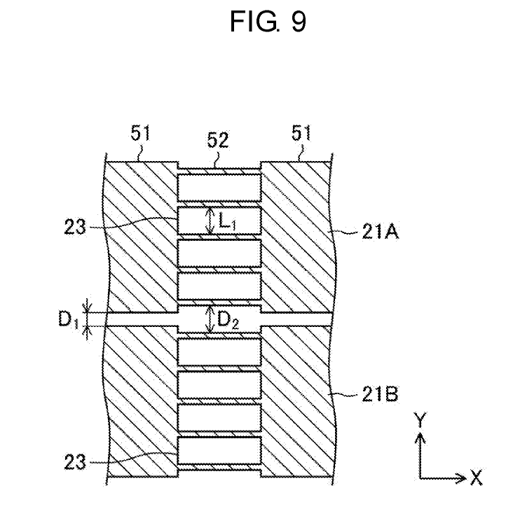

FIG. 9 is a partially enlarged plan view illustrating parts of electrode patterns of driving electrodes 21A, 21B adjacent to each other in the electrode pattern of FIG. 8.

As illustrated in FIG. 9, width L₁ of opening 23 in the Y-direction is equal to distance D₂ between narrow portions 52 of driving electrodes 21A, 21B adjacent to each other. When detection electrodes 31A to 31F are viewed from above along the Y-direction, a gap between opening 23 formed in each of driving electrodes 21A to 21F and narrow portion 52 of each of driving electrodes 21A to 21F adjacent to each other is uniformly arrayed as a region having an identical opening area. Consequently, the change in capacitance due to the detected position is substantially kept constant in the fringe field in the region, so that the more uniform detection sensitivity can be obtained.

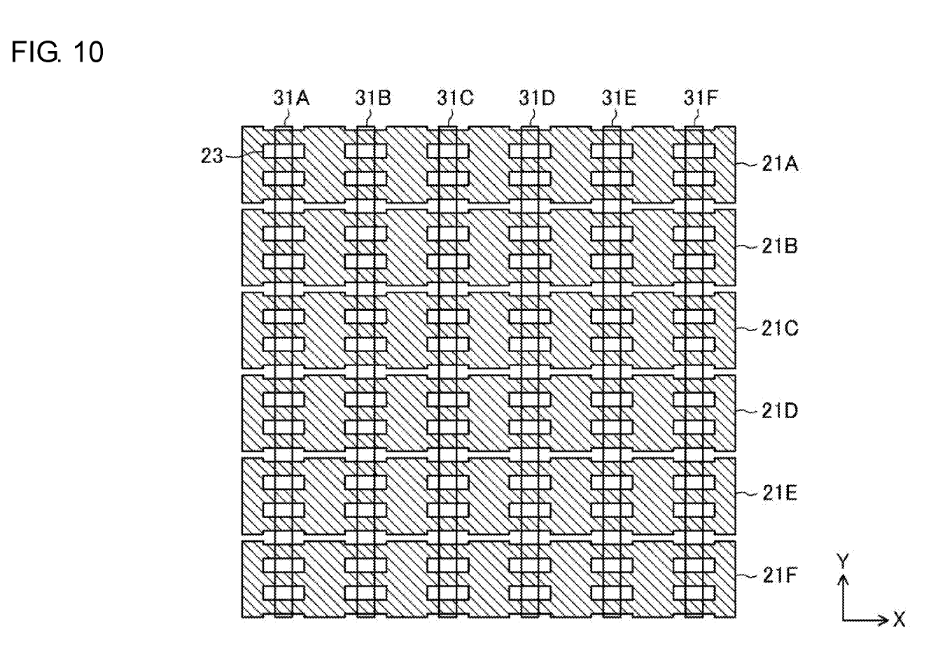

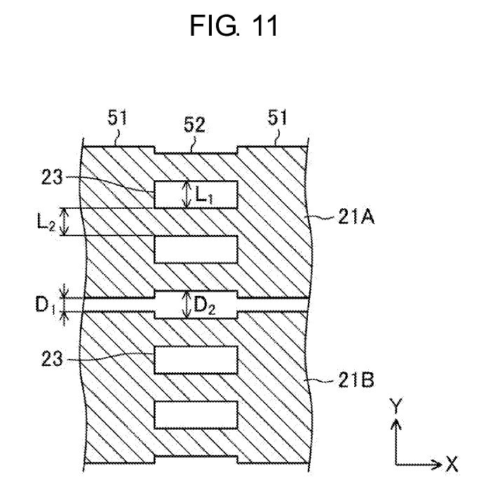

FIG. 10 is a plan view schematically illustrating an electrode pattern of a touch sensor according to a fourth exemplary embodiment of the present invention. FIG. 11 is a partially enlarged plan view illustrating parts of electrode patterns of driving electrodes 21A, 21B adjacent to each other in the electrode pattern of FIG. 10. In FIGS. 10 and 11, the plurality of driving electrodes 21A to 21F are hatched.

In the fourth exemplary embodiment, as illustrated in FIG. 11, width L₁ of opening 23 in the Y-direction is equal to distance L₂ between openings 23 adjacent to each other. Consequently, the degradation of the detection responsiveness caused by the decrease in electrode resistance of driving electrodes 21A to 21F can be prevented. Additionally, the change in capacitance due to the detected position is substantially kept constant by the fringe field in opening 23, so that the more uniform detection sensitivity can be obtained. It is effective when a material, such as ITO (Indium Tin Oxide) and a conductive polymer, which has high resistance, is used as the electrode.

In the fourth exemplary embodiment, by way of example, the electrode pattern of each of driving electrode 21A to 21F includes narrow portion 52 narrower than other regions (wide portion) 51 at the intersection as illustrated in FIG. 7. Alternatively, as illustrated in FIG. 3, the electrode pattern needs not to include narrow portion 52. For the electrode pattern including narrow portion 52, as illustrated in FIG. 11, width L₁ of opening 23 in the Y-direction is preferably equal to distance D₂ between narrow portions 52 of driving electrodes 21A, 21B adjacent to each other.

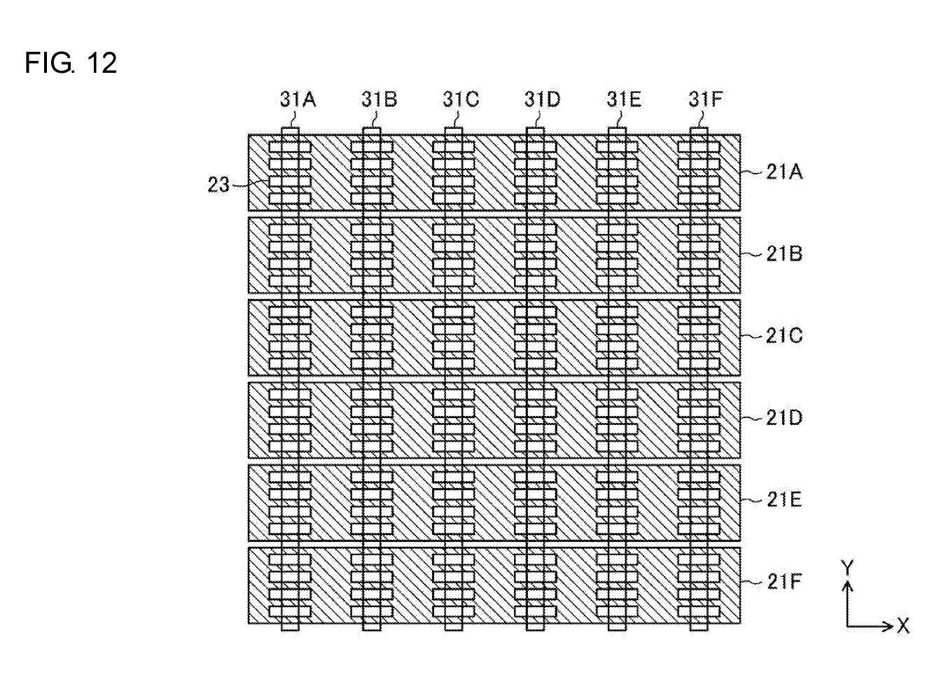

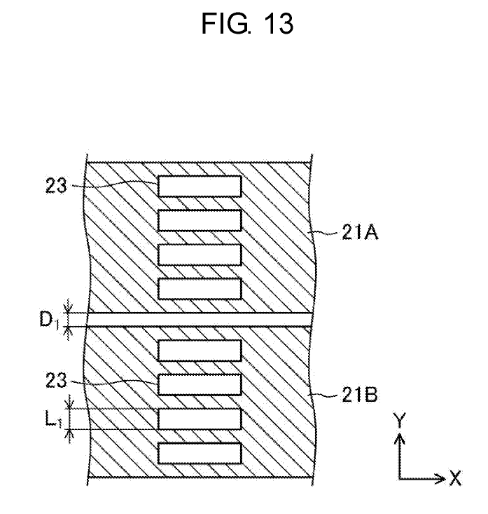

FIG. 12 is a plan view schematically illustrating an electrode pattern of a touch sensor according to a fifth exemplary embodiment of the present invention. FIG. 13 is a partially enlarged plan view illustrating parts of electrode patterns of driving electrode 21A, 21B adjacent to each other in the electrode pattern of FIG. 12. In FIGS. 12 and 13, the plurality of driving electrodes 21A to 21F are hatched.

In the fifth exemplary embodiment, as illustrated in FIG. 13, distance D₁ between driving electrodes 21A, 21B adjacent to each other is substantially equal to width L₁ of opening 23 in the Y-direction. The change in capacitance due to the detected position is substantially kept constant by the fringe field in opening 23, so that the more uniform detection sensitivity can be obtained.

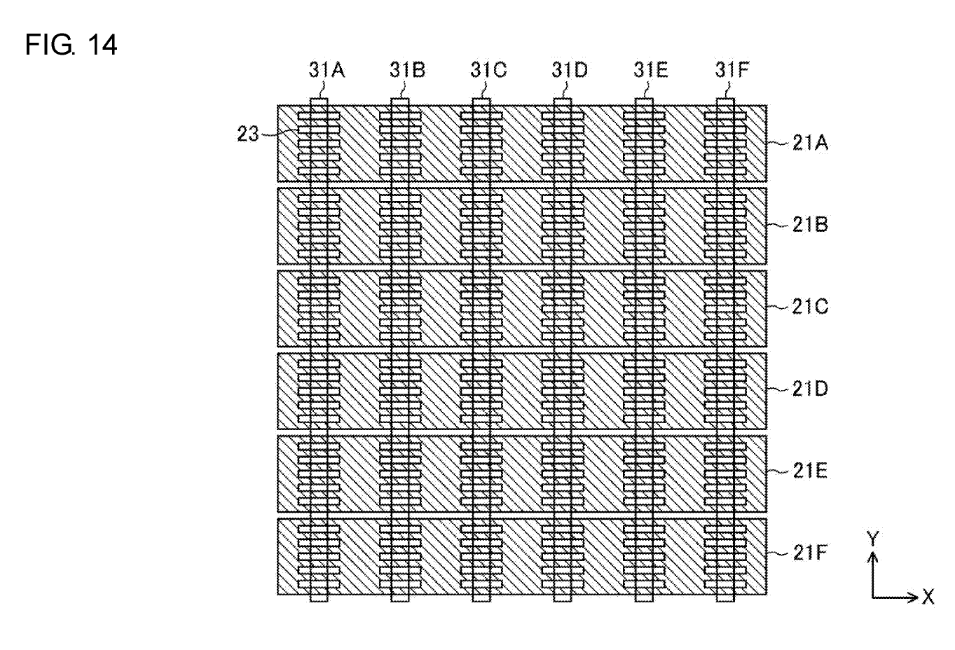

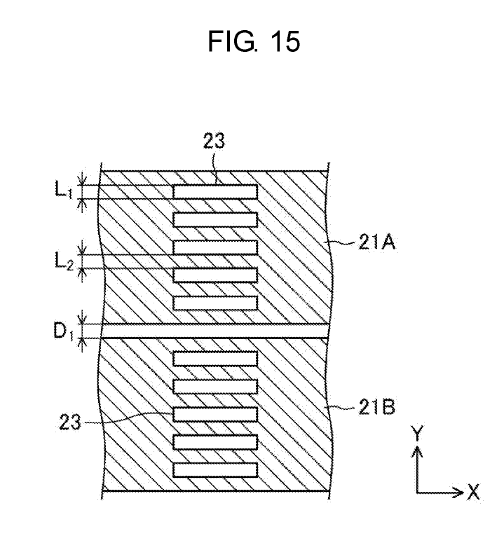

FIG. 14 is a plan view schematically illustrating an electrode pattern of a touch sensor according to a sixth exemplary embodiment of the present invention. FIG. 15 is a partially enlarged plan view illustrating parts of electrode patterns of driving electrodes 21A, 21B adjacent to each other in the electrode pattern of FIG. 14. In FIGS. 14 and 15, the plurality of driving electrodes 21A to 21F are hatched.

In the sixth exemplary embodiment, as illustrated in FIG. 15, width L₁ of opening 23 in the Y-direction is equal to distance L₂ between openings 23 adjacent to each other. The change in capacitance due to the detected position is substantially kept constant by the fringe field in opening 23, so that the more uniform detection sensitivity can be obtained.

As illustrated in FIG. 15, distance D₁ between driving electrodes 21A, 21B adjacent to each other is preferably equal to width L₁ of opening 23 in the Y-direction.

Although the preferred exemplary embodiments of the present invention are described above, the present invention is not limited to the above exemplary embodiments, but various modifications can be made.

For example, in the above exemplary embodiments, the plurality of driving electrodes 21A to 21F are disposed while the X-direction is set to the longitudinal direction of driving electrodes 21A to 21F, and the plurality of detection electrodes 31A to 31F are disposed while the Y-direction is set to the longitudinal direction of detection electrodes 31A to 31F. Alternatively, the plurality of driving electrodes 21A to 21F and the plurality of detection electrodes 31A to 31F may be disposed while crossing each other in any direction (the first direction and the second direction).

A material used for driving electrodes 21A to 21F and detection electrodes 31A to 31F and numbers of driving electrodes 21A to 21F and detection electrodes 31A to 31F can properly be selected according to required specifications of the touch sensor. For example, ITO can be used as the material constituting driving electrodes 21A to 21F and detection electrodes 31A to 31F.

The maximum width (for example, width A of opening 23 in the X-direction in FIG. 3) of opening 23 is preferably smaller than a half of the maximum width of the operating body that operates touch sensor 10. Consequently, since at least two openings 23 opposite to the operating body are obtained, the change in capacitance can be obtained in each opening 23, and detection accuracy of the position can be enhanced while the detection sensitivity is enhanced. The operating body has a pointed end shape such as the fingertip and the point of the touch pen, and performs the operation on the intersection of driving electrode 21A to 21F and detection electrodes 31A to 31F of touch sensor 10. The maximum width of the operating body means the maximum width of the fingertip for the fingertip, and means a diameter of a point portion for the touch pen.

In the above exemplary embodiments, a display device can be constructed by disposing the display panel on the side of driving electrodes 21A to 21F of the touch sensor.

### INDUSTRIAL APPLICABILITY

The present invention has the excellent detection sensitivity and detection responsiveness, and is useful for the touch sensor that can accurately detect the position and the input device equipped with the touch sensor.

### REFERENCE MARKS IN THE DRAWINGS

10 touch sensor
20 first support
21 driving electrode
22 first wiring
23 opening
30 second support
31 detection electrode
32 second wiring
40 insulating layer
50 cover
51 wide portion
52 narrow portion
52a recess

1. A touch sensor comprising:
at least two driving electrodes arranged at a predetermined interval while a first direction is set to a longitudinal direction of the at least two driving electrodes; and
at least two detection electrodes arranged at a predetermined interval while a second direction orthogonal to the first direction is set to a longitudinal direction of the at least two detection electrodes,
wherein
a width of each of the at least two driving electrodes is larger than a width of each of the at least two detection electrodes,
an opening is formed only in each of the at least two driving electrodes at a corresponding one of intersections of the at least two driving electrodes and the at least two detection electrodes,
the opening is one of a plurality of openings which are formed at intervals in the second direction, and
a width of each of the plurality of the openings in the second direction is equal to a distance between adjacent openings among the plurality of the openings.

2. (canceled)

3. (canceled)

4. (canceled)

5. (canceled)

6. (canceled)

7. (canceled)

8. (canceled)

9. (canceled)

10. A touch sensor comprising:
at least two driving electrodes lengthwise arranged along a first line at a predetermined interval; and
at least two detection electrodes lengthwise arranged along a second line at a predetermined interval, the first line being orthogonal to the second line,
wherein
a width of each of the at least two driving electrodes is larger than a width of each of the at least two detection electrodes,
an opening is formed only in each of the at least two driving electrodes at a corresponding one of intersections of the at least two driving electrodes and the at least two detection electrodes,
each of the at least two driving electrodes includes a narrow portion narrower than other portions at each of the intersections, and
a width of the opening in the second line is equal to a distance between the narrow portions of adjacent driving electrodes among the at least two driving electrodes.

11. A touch sensor comprising:
at least two driving electrodes arranged at a predetermined interval while a first direction is set to a longitudinal direction of the at least two driving electrodes; and
at least two detection electrodes arranged at a predetermined interval while a second direction orthogonal to the first direction is set to a longitudinal direction of the at least two detection electrodes,
wherein
a width of each of the at least two driving electrodes is larger than a width of each of the at least two detection electrodes,
an opening is formed only in each of the at least two driving electrodes at a corresponding one of intersections of the at least two driving electrodes and the at least two detection electrodes, and
a maximum width of the opening is smaller than a half of a maximum width of a pointed end-shaped operating body that performs operation on the intersections.

12. The touch sensor according to claim 1, wherein a width of the opening in the first direction is larger than the width of each of the at least two detection electrodes.

13. The touch sensor according to claim 1, wherein a distance between adjacent driving electrodes among the at least two driving electrodes is equal to a distance between adjacent openings among the plurality of the openings.

14. An input device comprising the touch sensor according to claim 1.

15. The touch sensor according to claim 10, wherein a width of the opening in the first direction is larger than the width of each of the at least two detection electrodes.

16. The touch sensor according to claim 10, wherein a distance between adjacent driving electrodes among the at least two driving electrodes is equal to a distance between adjacent openings among the plurality of the openings.

17. An input device comprising the touch sensor according to claim 10.

18. The touch sensor according to claim 11, wherein a width of the opening in the first direction is larger than the width of each of the at least two detection electrodes.

19. The touch sensor according to claim 11, wherein a distance between adjacent driving electrodes among the at least two driving electrodes is equal to a distance between adjacent openings among the plurality of the openings.

20. An input device comprising the touch sensor according to claim 11.
